(19) United States
(12) Patent Application Publication
(10) Pub. No.: US 2026/0169677 A1
(43) Pub. Date: Jun. 18, 2026

(54) METHOD FOR PLAYING BACK AUDIO FILES, AND ELECTRONIC COMPUTING DEVICE

(71) Applicant: MERCEDES-BENZ GROUP AG, Stuttgart (DE)

(72) Inventors: Monith BISWOJYOTHI, Bengaluru (IN); Udaya JOSHI, Bengaluru (IN); Suneel ATMAKURI, Hyderabad (IN)

(21) Appl. No.: 19/103,957

(22) PCT Filed: Jul. 25, 2023
(86) PCT No.: PCT/EP2023/070492

§ 371 Date: Feb. 14, 2025

(30) Foreign Application Priority Data
Aug. 16, 2022 (DE) 10 2022 002 994.4

(51) Int. Cl. G06F 3/16

(52) U.S. Cl. CPC G06F 3/165

(57) ABSTRACT

An audio file is played by an electronic computing device arranged in a vehicle. An audio file is wirelessly received by a mobile device from an external service provider, on at least one mobile device. The audio file from the mobile device is wirelessly transmitted to a first communication module of the electronic computing device. The audio file is stored in memory coupled to the electronic computing device. The audio is played back. At least one second audio file, which is provided by a second external service provider, is received by the mobile device and is stored in a data cloud. The electronic computing device is coupled to the data cloud and the first and the second audio file are transmitted from the data cloud to the electronic computing device for playback.

### BACKGROUND AND SUMMARY OF THE INVENTION

Exemplary embodiments of the invention relate to a method for playing back audio files by means of an electronic computing device arranged in a vehicle, as well as to an electronic computing device.

For playing back audio files and thus for playing music, songs, playlists, as well as videos and other media, according to the current state of the art, infotainment systems provided in particular by electronic computing devices already arranged in the vehicle are used. Such an infotainment system in a car, in particular in a passenger car and/or in other vehicles, can normally only be accessed by the passengers sitting in the front first row of seats (driver and front passenger). If passengers sitting in the second or third row of seats wish to use the infotainment system, for example to listen to a certain song, they have to ask the passengers in the first row of seats to assist them at least partially with operating the infotainment system. This is inconvenient for the passengers sitting in the rear seats, since they always have to depend on the passengers in the first row of seats when selecting songs. Likewise, the other passengers in the rear seats in many cases receive no information about the song selection or the playlists, as the infotainment system can essentially only be operated by the front passengers.

At present, for example, an infotainment system “Juke Box Car app” is already known which uses a mobile internet access point “hotspot” to create a virtual network and provide a service for the shared use of playlists by the passengers in the vehicle. However, this product only plays audio files from the respective internal memory of mobile devices connected to the network, with mobile devices being designed here in particular as mobile phones, tablets, PCs and so on.

US 2021/0 204 102 A1 disclosed a method in which a plurality of devices use a service linked to a first device. The method comprises the following steps: performing a connection to a central display device and mirroring the service to the central display device based on a playlist of services stored in the first device; receiving a change request for the playlist from a second device and updating the playlist to correspond to the change request; and transmitting information related to the updated playlist to the central display device. Therefore coupled devices are intended to be used to provide playlists.

By way of example, U.S. Pat. No. 10,275,211 B2 disclosed such an apparatus and a method for playing back audio in a vehicle. The apparatus comprises an audio device having a memory, which is operatively coupled to a plurality of mobile devices in a vehicle. The audio device is programmed in such a way that it wirelessly receives audio files from the plurality of mobile devices and stores these audio files in the memory. In addition, the audio files are played back via the loudspeakers in the vehicle. By means of the method, the audio files are received wirelessly from respective mobile devices in the vehicle for the purpose of audio playback in the vehicle. In addition, the audio files are stored in a memory and these are played via the loudspeakers in the vehicle. The audio files are played back sequentially from the memory via the loudspeakers, based on an order in which the audio files from respective mobile devices were stored in the memory.

Furthermore, DE 10 2015 201 453 A1, US 2016/0 328 471 A1, US 2015/0 228 000 A1 and DE 10 2018 200 133 A1 disclose further systems or methods, by means of which audio files from external devices can be played.

Accordingly, although it is possible to transmit and play back video and/or audio files via a computer network of the mobile devices by a data stream or stream them on mobile devices by means of external streaming service providers, transmission of the audio files provided by external streaming service providers to the vehicle, in particular to the infotainment system, is however limited and usually only possible via wireless coupling, in particular via Bluetooth. Transmitting audio files from various external streaming service providers to a playlist cannot be inferred from the current state of the art.

This means that the audio files to be played either have to be stored in an internal memory of the respective mobile devices, in order to then be played back by means of the wirelessly coupled electronic computing device and by means of the infotainment system or exclusively audio files from a single external streaming service provider must be transmitted via an application from the mobile device to the electronic computing device and thus to the infotainment system. Changing the external streaming service provider would mean a re-coupling to a new mobile device or switching over the application on the mobile device. A disadvantage is in particular the time required to re-couple mobile devices to the electronic computing device and to the infotainment system. Although it would be possible to provide a plurality of communication modules on the electronic computing device in order to couple a plurality of mobile devices simultaneously, the coordination between the mobile devices as well as the coordination of the audio files would, however, require RAM and additional components in the electronic computing device, for example, whereby these and the infotainment system would be unnecessarily burdened.

Exemplary embodiments of the invention provide a method for playing back at least one audio file by means of an electronic computing device arranged on a vehicle, by means of which audio files provided by several external streaming service providers are combined from a plurality of mobile devices coupled to the electronic computing device to form a playlist and are played back.

One aspect of the invention relates to a method for playing back at least one audio file, in particular a plurality of audio files and/or playlists, by means of an electronic computing device arranged in a vehicle and in particular with an infotainment system provided by the electronic computing device. Although it is possible to add all of the components required for operating the method, it is however particularly advantageous to use components that are already present in the vehicle. In particular, the electronic computing device has at least one first communication module, which is designed to be connected to a network, in particular the internet, whereby data, information, messages etc. are transmitted and/or received. Similarly, the electronic computing device has at least one second communication module, which is designed to be wirelessly coupled, in particular via Bluetooth, infrared or other wireless networks, to respective mobile devices, in particular for transmitting audio files. In this case, audio files are to be played back by creating or compiling one and/or a plurality of playlists, with the playlist describing a list of audio or video files in a specified playing order. In this compilation of digital audio files, they can be played in all formats, for example MP3, WAV, AIFF, WMA or others, by the electronic computing device and by the provided infotainment system. It is similarly provided that new media formats such as MP4, which also contain music, are also played back.

To carry out the method, first method steps are needed to play back an audio file. Here, in a first method step, the at least one audio file that is provided by an external service provider, in particular external streaming service provider, is wirelessly received on at least one mobile device. For this purpose, according to the current state of the art, most mobile devices have a respective first communication module, which is designed to be connected to a network, in particular the internet, whereby data, information, messages are transmitted and/or received. Certain external service providers enable the streaming of media (streaming media), thereby enabling simultaneous transmission and playing back of video and/or audio files over a computer network by a data stream in particular via the external service provider's own application. In contrast to downloading, the aim here is not to create a copy of the audio files/media for the user, but to play back/play the audio files/media directly, and then the copies are discarded. Thus, the streamed audio file is transmitted over a network and via the first communication module to the mobile device of the user and provided for playback, where, in the normal case, such a mobile device is designed as a mobile telephone, a tablet computer, a computer or the like, which has at least the components and communication modules in order to be coupled to an electronic computing device and/or to a network, in particular the internet, and/or to a Bluetooth network and in order to download applications for streaming audio files from a network.

In a second method step, the at least one audio file, in particular a plurality of audio files, is wirelessly transmitted from the mobile device to the second communication module of the electronic computing device, in particular by Bluetooth. This means that although it is possible to play back the audio files on the mobile device by means of associated components of the mobile device, for example integrated loudspeakers, it is provided according to the invention however to transmit the audio files to the electronic computing device and to play them back by means of the vehicle's infotainment system. The audio files are transmitted via respective second communication modules arranged on the respective mobile devices, which like the second communication module of the electronic computing device transmit and/or receive the audio files and further data, in particular by Bluetooth, with other wireless connections/couplings being possible here as well. By transmitting the audio files from the mobile device to the electronic computing device, the audio files can be played back by means of loudspeakers and loudspeaker devices provided by the vehicle. Thus, the audio files or the music/songs are forwarded indirectly from the external service provider to the infotainment system, whereby the mobile device is used as an intermediate station for playback. This is because, although the mobile device streams the audio files, the playback time is however determined by means of the infotainment system. In particular, the infotainment system thus coordinates the playlists and the options and settings for playing back all audio files in such a playlist.

In other words, the mobile device is connected to the electronic computing device and thus to the infotainment system. The wireless connection and/or physical connection with a cable used for this purpose enables the audio files to be played back via the infotainment system. The electronic computing device receives, for example, a signal from the mobile device, whereby the infotainment system knows that a playing back of audio files is desired. However, the playback is only possible once the infotainment system sends back a signal by means of the electronic computing device, which signal transmits an authorization to play back the audio file. Thus, the audio file is approved for playback by the infotainment system, with it being possible to adjust the operation of the playback or further playing possibilities and/or options/settings relating to the playback both via the infotainment system and also via the mobile device coupled to the electronic computing device. By disconnecting the wireless connection, in particular Bluetooth connection, between the respective second communication modules of the mobile device and the electronic computing device, it is possible to couple other mobile devices of other users to the electronic computing device and thus to connect them to the infotainment system, so that streaming via other mobile devices is also possible. As a result it is possible to transmit various audio files of various users from different mobile devices to the electronic computing device, with it is also being possible to use various external service providers on one mobile device, thereby providing a variety of streaming possibilities. Due to the connection to the electronic computing device and due to a playback authorization which can be set depending on the settings of the infotainment system, are thus all audio files are transmitted and played back/played via the vehicle's loudspeakers that are coupled to the electronic computing device.

In order to play different audio files, it is provided according to the invention that, in a third method step, the at least one audio file is stored in a memory coupled to the electronic computing device. This means that all audio files that are transmitted to the electronic computing device are temporarily stored in the memory to which the infotainment system has access and from which the audio files can be played back. It is also possible to provide playlists that are constructed in the order in which the audio files were stored in the memory. Thus, for example, each audio file has a specified time point and an identification by means of which a priority is assigned and the order of the playback is determined. Such a memory can, for example, already be present in the vehicle, in particular as an SD card, whereby the transmission of audio files and the playing back is substantially independent of outside influences or networks.

In addition, in a fourth method step, the at least one audio file is played back out, in particular by the loudspeaker of the vehicle, and in the specified order in which the audio files were stored. Options for repeat playback and other options can be controlled via the mobile devices or via the infotainment system.

In order to solve the object of the invention and thus provide a method for playing back the at least one audio file by means of the electronic computing device arranged on the vehicle, it is provided according to the invention that at least one second audio file which is provided by a second external service provider that is different to the first external service provider is received by means of the at least one mobile device. This means that the mobile device receives the first and the second audio file from different external service providers and forwards them to the memory of the infotainment system, whereby it is possible to play back two audio files provided by two external service providers.

In addition, it is provided according to the invention that the second audio file is stored in the memory which is designed as a data cloud. This memory is therefore not internal and designed as an SD card for example, but is provided as a data cloud by means of a network and an associated platform and an associated server, which can be provided both by the OEM and by a service provider.

It is also provided according to the invention that the electronic computing device is coupled to the data cloud and the infotainment system thus receives an authorization to access the data cloud, whereby all data and information is downloaded from the data cloud and/or stored in the data cloud. It is provided according to the invention to store audio files, however it is also possible to store the information about users and user accounts, which are linked to the data cloud, in the data cloud. This makes it easier to register the mobile devices and the user accounts in the future, since certain information is only requested and secured once. Presettings, playlists and further options for playing back the audio files can also be stored in the data cloud.

In addition it is provided according to the invention that the first and the second audio file are transmitted from the data cloud to the electronic computing device for playback. Although the downloading and immediate playback is advantageous and according to the invention, it is also possible to store the audio files temporarily, whereby, for example, time delays in downloading audio files from the data cloud are bridged depending on a transmission speed of the network and wherein, for example, a predetermined number of audio files are downloaded even before the playback, in order to already be available for playback in the event of a connection interruption. The playback duration of the already downloaded audio files provides a time buffer for reestablishing a connection. It is likewise possible to play an already downloaded audio file again, in order to provide a longer time buffer. Alternatively, it is possible to designate an audio file or a playlist that is provided in an internal memory to extend the time buffer so that it can be played at any time, in particular in the case of longer-lasting network problems and failed connection attempts.

Lastly, it is also provided according to the invention that audio files that are transmitted directly to the first communication module of the electronic computing device are stored by the electronic computing device in the coupled data cloud. This method step means that interruptions in the connection of the mobile device do not prevent the uploading of audio files to the data cloud when the electronic computing device continues to maintain a connection to the network, in particular the internet. For example, this can be the case if the contractually stipulated range of the mobile device and/or lack of data volume limit the transmission of audio files to the data cloud. As a result, only the transmission from the external service provider to the mobile device would use data volume, and the transmission to the electronic computing device and the data exchange between electronic computing device and data cloud are then independent of the data volume of the mobile device. Particularly in the case of media having a very large file size such as videos, this embodiment would lead to data volume being saved.

In other words, it is provided by the method according to the invention that, in particular, an interface between two external service providers is enabled, thus making it possible to play audio files from different sources. Furthermore, instead of using an internal memory of the electronic computing device, a data cloud is employed. The provided data cloud by contrast is connected to the electronic computing device via a communication module and via a network, whereby the infotainment system can access the audio files stored in the data cloud. In particular it is possible to store a plurality of audio files streamed from a plurality of external service providers in the data cloud for streaming. As a result it is possible to couple the electronic computing device to the data cloud and to transmit the first and the second audio file to the electronic computing device in order to play them back through the infotainment system and through the loudspeakers coupled to the electronic computing device. The mobile devices connect to the data cloud, transmit the audio files to the data cloud, and create a playlist. The electronic computing device accesses the data cloud and plays the playlist and/or the audio files in the order in which the mobile devices have stored the audio files and/or playlists. In order to have access to an interface and thus access to the data cloud, the mobile device can, for example, have an application corresponding to the method and to the infotainment system and which in particular is provided by the OEM. In particular, the application is provided for the connection between the electronic computing device and the mobile device, whereby both of these can control the playback and further options/settings. The application can also be developed such that it replaces the infotainment system and/or is linked to the infotainment system and/or interacts therewith. For example, a frontend of the application can be used both on the electronic computing device and via the coupled user interface as well as on the mobile devices. Similarly, for example, a backend of the application is stored on the server of the data cloud, with it being possible to modify the design of the application and the required components.

For the creation of an application according to the invention, it is in particular provided to use freely accessible software “open source” and/or freely accessible programming tools and program libraries for developing software “software development kits” (SDKs) from open source providers, for example.

In particular, in addition to audio files, all other files can be provided for playback in streaming services, for example video or other media files, in particular music videos and films, which are played on screens in the vehicle, for example. As a result, it is possible not only to stream the audio files for listening to music and to store them in a data cloud, but also films and videos, for example for entertaining children sat on the back seat.

In an advantageous embodiment of the invention, it is provided that further audio files from a further, internal second memory are played back by the electronic computing device and thus also by means of the infotainment system. This means that not only are streamed audio files added to the playlist, but that it is likewise possible to add audio files to the playlist that have already been downloaded and/or do not have to be downloaded from the network. Such a second internal memory can be an SD card, for example, but also customary audio file memories such as CDs, MP3 players, mobile devices without internet access connected by means of cables, etc., with a respective device being employed to transmit the respective audio files.

In a further advantageous embodiment of the invention, it is provided that the first and the second audio file are transmitted directly to the second communication module of the electronic computing device by means of respective second communication modules of the respective mobile devices. It is ostensibly possible to couple the electronic computing device to the mobile devices via a Bluetooth interface, whereby the electronic computing device transmits/uploads the audio files to the data cloud, in order to download and play them back at the desired time. In addition to the Bluetooth interface, cable connections are also provided in this case, or other wireless or cabled connections which lead to the transmission of the audio files to an internal memory of the electronic computing device. However, these audio files are only stored temporarily and are played back for example at a predefined point in time, in particular if there is a break in network connection, in particular the internet. In addition, for example, media formats can also be mixed in such a way that a playlist is played but a video is only played if the time provided therefor permits this. Transmitting a video on the data cloud would use up a lot of data, so it is provided via the Bluetooth interface.

Likewise advantageous is a further embodiment of the invention in which a playlist composed of the audio files stored in the data cloud is controlled via the mobile devices and via a user interface of the electronic computing device. The control is carried out in particular via the infotainment system or via a provided application, with it being provided in particular to use already existing components or freely accessible software and servers and databases, as a result of which a cost reduction for the development and for the provision of the embodiment of the method is possible.

In addition, in a further advantageous embodiment, when removing audio files from the playlist, a removal authorization is checked. With such an option to remove further audio files, a request should be made to check whether the user removing the audio file also added it to the playlist. This prevents unauthorized removal of audio files from the playlist. The main aim here is to provide a secure way for all users to play back the desired audio files without their own audio files being skipped or removed by other users. This creates a desired level of fairness when playing back audio files and substantially prevents an unwanted waste of data volume. When a user attempts to remove a file, a request is made to see if there is a match when comparing a device ID (device identifier) assigned to the audio file to be removed with the device ID of the user. In particular, when an audio file is stored on a playlist, a device ID of the storing mobile device should be assigned to the stored audio file. With this identifier, the audio file is assigned to a mobile device and can only be removed from this mobile device. Alternatively, the audio file is assigned a user ID (user identifier).

Lastly, it is provided in a further advantageous embodiment of the invention that at least one item of information about at least one user of one of the mobile devices is stored in the data cloud. Although it is provided according to the invention to store audio files, it is also possible, however, to store information about users and user accounts, which are linked to the data cloud, in the data cloud. This makes it easier to log on to the infotainment system or the application on the mobile devices in the future, since certain information is only requested and secured once. Presettings, playlists and further options for playing back the audio files can also be stored in the data cloud.

The main idea according to the invention idea here is to combine/couple in particular popular music streaming apps from different providers in a mobile application and to enable the passengers and thus users of the method to stream music from any source by means of their respective mobile devices, including songs from the internal memory of the mobile devices. For this purpose, cable-less connections between a plurality of mobile devices, in particular Bluetooth connections or infrared or other connections between a plurality of mobile phones, are switched at least partially automatically, in particular automatically and seamlessly, by means of a script according to the invention, in particular by means of a python script.

A further aspect of the invention relates to an electronic computing device for playing back audio files, comprising a first communication module, by means of which the electronic computing device can be coupled without a cable to a data cloud, in particular via a network, in particular the internet. The electronic computing device also has at least one second communication module that is different to the first communication module and by means of which the electronic computing device can be coupled without a cable to at least one mobile device. This communication module is designed in particular as a Bluetooth module. In addition, the electronic computing device has a loudspeaker device, arranged connected using an electronic connection, with at least one loudspeaker and a user interface arranged connected using a further connection. An application that can be used on the electronic computing device can be displayed by means of the user interface. The audio files can be played back by means of the loudspeaker device. The electronic computing device is designed to store and play back all audio files in the data cloud in an order, depending on signals sent to the communication modules from the respective mobile devices.

In other words, it is essentially possible to bypass a switch function in the case of which the electronic computing device constantly switches the connection between different mobile devices and the computing device's own communication module. Since only one mobile device at a time can connect to these communication modules, an option to buffer store audio files, in particular streamed audio files, in the data cloud is provided here. This means that the mobile devices store the songs directly on the data cloud, whereby the electronic computing device only has to establish a connection with the data cloud. Alternatively, however, a communication module, in particular a Bluetooth interface between electronic computing device and mobile device, can also be used to add the audio files in the playlist to the data cloud. As a result there are at least two possible ways of adding audio files to the data cloud. Further options via cable connections or further networks are also possible.

In an advantageous embodiment of the electronic computing device it is provided that the electronic computing device is designed to buffer store and play back audio files stored in the data cloud. In particular, it should be possible here to buffer store the audio files in a predefined time period, so that in the event of a network interruption, playback is not also interrupted. The buffer storing takes place, for example, via an internal memory, in particular an SD card of the electronic computing device.

In a further advantageous embodiment of the electronic computing device, it is provided that the electronic computing device is designed as a single-board computer for emulating an infotainment system of a vehicle and/or for coupling to such an infotainment system. In this case, an electronic computing device is used, in particular a single-board computer, by means of which first a user experience (UX) infotainment system, in particular an MBUX infotainment system, is emulated. The emulation is intended to control cable-free connections, in particular Bluetooth connections, which alternate or are switched between the end devices. The reason for this in particular is to control the individual output and input ports of respective Bluetooth modules of respective end devices, since these only allow a single connection at a time. This applies both to Bluetooth and to other cable-free connections.

The mobile app uses a real-time cloud database to store all playlists, user information, Bluetooth identification (Bluetooth Unique ID (BT-UID)) of the end devices and any other necessary information.

It is thus provided according to the invention that all passengers in a vehicle install the mobile application onto their device, in particular an Android smartphone, and connect the devices via Bluetooth to the infotainment system that is already present in the vehicle, in particular an MBUX infotainment system. Each passenger can select multiple songs from any music streaming app and add them to a playlist or a queue list, which is accessible and visible in real time for all other passengers on their respective devices. Respective passengers can also add already played songs from their own favorites list in their own user account to the playlist in installed music streaming apps and/or access these songs later from a history or history list of already played songs.

All playlists, together with the name of the respective user who has played it, are stored in a cloud database, which remains connected at all times to all end devices on which the app is installed and to which the vehicle's infotainment system is connected, thereby enabling essentially seamless updating of the lists.

### Additional Functions

Active suggestions: song suggestions from family/friends from online playlists for solo travelers, where the driver or passenger confirms a prompt, whereby song suggestions are permitted to be received.
Combining songs: Because some people have a brief attention span they sometimes alternate between songs. The app automatically combines songs or automatically creates a “song mash-up”, which is based on the history of the travelers. A mash-up algorithm, which is provided in the cloud database, is forwarded to the passengers as soon as it is ready for downloading.

### Advantages of the Invention

A particular advantage of the infotainment system according to the invention is the option to enable access to the infotainment system for plurality of users or passengers, who attempt to connect to the vehicle's infotainment system one after the other and to transmit their personal selection of audio files from popular music streaming apps. In addition, the infotainment system allows each passenger in the vehicle to access the playlist, to check and add audio files from the playlist, and to check audio files from the favorites list and add them to the playlist.

In addition, it is only possible to delete audio files in the playlist if the user has also added them. Not every user can change the playlist, but they can change their own favorites list. Lastly, the infotainment system according to the invention does not require the installation of external music streaming apps in the infotainment system itself, thereby reducing license costs, development costs and the load on the controller.

Further advantages, features and details of the invention result from the following description of preferred exemplary embodiments and with reference to the drawings. The features and feature combinations mentioned above in the description and the features and feature combinations mentioned below in the description of the figures and/or shown alone in the figures can be used not only in the respectively specified combination, but also in other combinations or in isolation, without departing from the scope of the invention.

### BRIEF DESCRIPTION OF THE DRAWING FIGURE

The figures show:

FIG. 1 a diagram illustrating an embodiment of a method according to the invention for playing back at least one audio file by means of an infotainment system in a vehicle;

FIG. 2 a diagram illustrating an operating mode of a home screen and a mobile device with a display displaying the home screen;

FIG. 3 a diagram illustrating an operating mode of a main activity of the method and a mobile device with a display displaying the main activity;

FIG. 4 a diagram illustrating an operating mode of a first search for audio files by means of the method and a mobile device with a display displaying the first search;

FIG. 5 a diagram illustrating an operating mode of a log-in display on an external service provider's platform by means of the method and a mobile device with a display displaying the log-in display;

FIG. 6 a diagram illustrating an operating mode of a second search for audio files by means of the method and a mobile device with a display displaying the second search;

FIG. 7 a diagram illustrating an operating mode of a third search for audio files by means of the method and a mobile device with a display displaying the third search;

FIG. 8 a diagram illustrating an operating mode of a removal option for removing audio files from a playlist by means of the method and a mobile device with a display displaying the removal option;

FIG. 9 a diagram illustrating an operating mode of creating a favorites list by means of the method and a mobile device with a display displaying the favorites list; and

FIG. 10 one last diagram illustrating an operating mode of creating a history by means of the method and a mobile device with a display displaying the history.

In the figures, identical and functionally identical elements are provided with the same reference signs.

### DETAILED DESCRIPTION

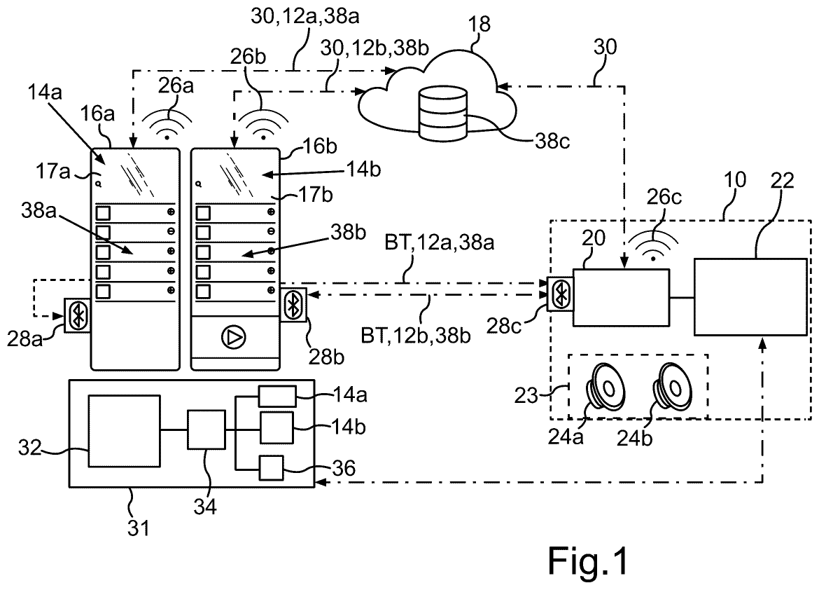

FIG. 1 shows a diagram illustrating an embodiment of a method according to the invention for playing back at least one audio file 12a by means of an electronic computing device 20 arranged on a vehicle. Here, audio files 12a, 12b and/or playlists 38a, 38b from external service providers 14a, 14b are to be forwarded via respective mobile devices 16a, 16b to a data cloud 18 and stored for a predefined time. The electronic computing device 20 is designed to receive the audio files 12a, 12b and/or playlists 38a, 38b from the data cloud 18, wherein the options and settings for playing back the audio files 12a, 12b and/or playlists 38a, 38b and for controlling the electronic computing device 20 can be used by means of an arranged user interface 22. In particular, the method and the playing back of the audio files 12a, 12b and/or playlists 38a, 38b can be controlled by means of an infotainment system 10 or by means of an application 31 developed therefor. Lastly, the individual audio files 12a, 12b of the playlists 38a, 38b are transmitted via the electronic computing device 20 to respective loudspeakers 24a, 24b of a loudspeaker device 23 of the vehicle in a predefined order, whereby it is possible to play back/play the audio files 12a, 12b in sequence and whereby it is possible in particular to playing back audio files 12a, 12b and/or playlists 38a, 38b from different mobile devices 16a, 16b on a mixed playlist 38c.

In other words, it is possible to play audio files 12a, 12b and/or playlists 38a, 38b mixed together from different sources, and for this purpose the different mobile devices 16a, 16b, in particular mobile phones or tablet computers, are coupled to the electronic computing device 20 and/or to the infotainment system 10 in the vehicle and/or to the application 31. The mobile devices 16a, 16b have respective first communication modules 26a, 26b for sending and/or for receiving signals, data, information and/or messages, by means of which in particular the respective audio files 12a, 12b and/or playlists 38a, 38b to be transmitted to the data cloud 18 are transmitted without a cable over a network 30, in particular over the internet, with all other cable-free networks also being possible.

By contrast, the electronic computing device 20 has its own first communication module 26c, by means of which signals, data, information, and/or messages are likewise transmitted to the data cloud 18 and/or received from the data cloud 18. As a result, using the network 30, both the mobile devices 16a, 16b and the electronic computing device 20 can establish a respective interface with the data cloud 18. Such a connection for data exchange with the data cloud 18 is effected in particular over the internet or over other networks, which are available to the vehicle and thus the infotainment system 10, the mobile devices 16a, 16b and the electronic computing device 20 and the application 31.

In addition, the respective mobile devices 16a, 16b have respective second communication modules 28a, 28b for sending and/or for receiving signals, data, information and/or messages, where these are preferably Bluetooth modules for the creation of a network connection by means of Bluetooth BT, and whereby the respective mobile devices 16a, 16b can be coupled to the electronic computing device 20, in particular via Bluetooth BT. For this, the electronic computing device 20 likewise has a second communication module 28c, by means of which it is possible to couple to the mobile devices 16a, 16b, in particular via Bluetooth BT.

It is therefore provided that the mobile devices 16a, 16b and the electronic computing device 20 are connected to the data cloud 18 via the network 30, in particular the internet, by means of the respective first communication modules 26a, 26b, 26c. At the same time, the mobile devices 16a, 16b should likewise be connected to the electronic computing device 20 via the respective second communication modules 28a, 28b, 28c, in particular via Bluetooth BT. The audio files 12, 12b can likewise be transmitted and/or playlists 38a, 38b are likewise transmitted via Bluetooth BT to the electronic computing device. In addition to Bluetooth BT, as shown in FIG. 1, other cable-free/wireless functions are also possible, for example infrared, WLAN and so on, with it being provided according to the invention to use components already available on the mobile devices 16a, 16b or data transmitters and data receivers. In particular, to implement the method and to provide the application 31 with software, a predefined programming language is used, with a suitable freely accessible programming library 32 and a suitable freely accessible programming tool 34, where the application 31 is designed to establish an interface with the external service providers 14a, 14b and with an internal memory 36 and/or the data cloud 18.

In particular, the data cloud 18 is in the form of a Google Firebase Realtime Database, the electronic computing device 20 designed as a Raspberry Pi microchip for emulating an MBUX infotainment unit system, on which the loudspeaker device 23 with the loudspeakers 24a, 24b designed as wired in-speakers are arranged. The user interface 22 is represented in particular by a graphical user interface GUI of the Raspberry Pi. The connection between the mobile devices 16a, 16b and the electronic computing device 20 is provided by Bluetooth music streaming via Bluetooth BT. For the design of the mobile application 31, an Android Studio is used in particular as programming library 32, an Android Package s is used in particular as programming tool 34, and the external service providers 14a, 14b can be different, with YouTube and Spotify being particularly preferred. Lastly, the internal memory 36 is represented in particular by an SD card. All of the abovementioned examples can vary, however, and can be replaced and/or exchanged depending on the OEM's specifications; in other words, these components are exemplary and in no way final. However, the architecture for providing the method is shown according to the invention with the diagram in FIG. 1.

The invention provides a method for playing back the audio files 12a, 12b by means of the electronic computing device 20 arranged on the vehicle with an associated infotainment system 10 or a dedicated application 31. In a first method step, the audio files 12a, 12b provided by the external service providers 14a, 14b and/or a plurality of audio files 12a, 12b and/or playlists 38a, 38b are wirelessly received on the mobile devices 16a, 16b. In a second method step, the audio files 12a, 12b and/or playlists 38a, 38b are wirelessly transmitted from the mobile devices 16a, 16b to the electronic computing device 20. In a third method step, the audio files 12a, 12b and/or playlists 38a, 38b are stored in a memory coupled to the electronic computing device, here in particular the data cloud 18. Lastly, in a fourth method step, the audio files 12a, 12b and/or playlists 38a, 38b are played back by means of the electronic computing device 20 and the loudspeaker device 23 using the infotainment system 10 and/or the application 31.

To solve the object of the invention and thus play back the audio files 12a, 12b and/or playlists 38a, 38b, it is provided according to the invention that, in a next, fifth method step, the audio files 12a, 12b from the different external service providers 14, 14b are received by means of the mobile devices 16a, 16b and are stored in the data cloud 18 in a sixth method step. Thereafter, the electronic computing device 20 is coupled to the data cloud 18, in particular using the infotainment system 10 and/or the application 31. Lastly, in a final, seventh method step, the audio files 12a, 12b and/or playlists 38a, 38b are transmitted from the data cloud 18 to the electronic computing device 20 for playback by means of the loudspeaker device 23, likewise using the infotainment system 10 and/or the application 31 for playback.

In other words, the audio files 12a, 12b and/or playlists 38a, 38b of respective external service providers 14a, 14b are made available by respective mobile devices 16a, 16b, in particular by a streaming service, wherein the mobile devices 16a, 16b store the respective audio files 12a, 12b and/or playlists 38a, 38b in the data cloud 18 in a mixed playlist 38c. The electronic computing device 20 coupled to the data cloud 18 is designed to play back the audio files 12a, 12b and/or playlists 38a, 38b and/or mixed playlist 38c stored in the data cloud 18 via the loudspeakers 24a, 24b that are likewise coupled to the electronic computing device 20. Thus, the audio files 12a, 12b and/or playlists 38a, 38b and/or mixed playlist 38c are transmitted over the network 30 from the data cloud 18 to the electronic computing device 20, whereby an indirect forwarding of the audio files 12a, 12b and/or playlists 38a, 38b from the external service providers 14a, 14b to the electronic computing device 20 and thus playback is possible.

That then means that the electronic computing device 20 can use the infotainment system 10 and/or the application 31 to play back a mixed playlist 38c consisting of the audio files 12a, 12b and/or more audio files and/or playlists 38a, 38b, with the audio files 12a, 12b and/or playlists 38a, 38b coming from different sources, in particular from different mobile devices 16a, 16b, which again are provided and streamed by different external service providers 14a, 14b.

It is furthermore provided that audio files 12a, 12b transmitted directly to the electronic computing device 20 via Bluetooth BT or a cable connection are stored by the electronic computing device 20 in the coupled data cloud 18. This method step means that connection interruptions of the mobile devices 16a, 16b do not prevent audio files 12a, 12b and/or playlists 38a, 38b from being uploaded to the data cloud 18, as long as the electronic computing device 20 continues to maintain a connection to the network 30, in particular the internet.

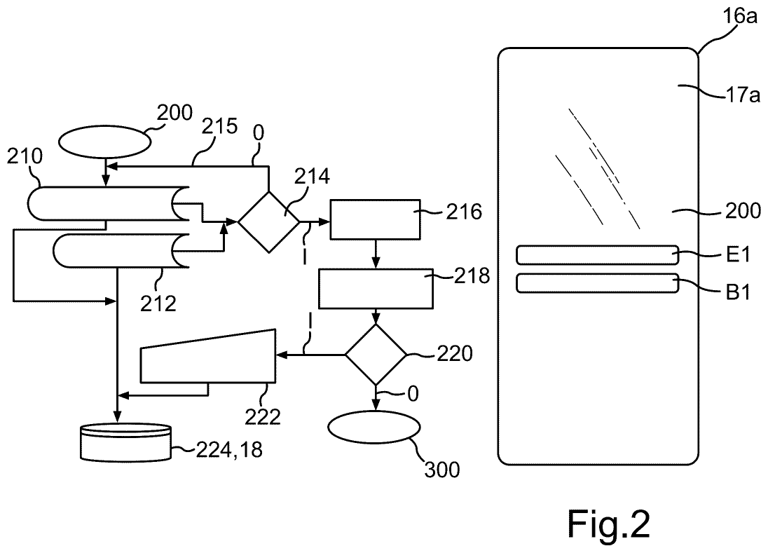

FIG. 2 shows a diagram illustrating an operating mode of a home screen 200 of the application 31 as well as the first mobile device 16a with a display 17a displaying the home screen 200.

In order to have an interface and thus access to the data cloud 18, the mobile devices 16a, 16b can have the application 31, which in particular is provided by the OEM. In particular, the application 31 is provided for the connection between the electronic computing device 20 and the mobile devices 16a, 16b, whereby both of these can control the playing back and further options/settings. The application 31 can also be developed such that it replaces the infotainment system 10 and/or is linked to the infotainment system 10 and/or interacts therewith. For example, a frontend 40 of the application 31 can be used both on the electronic computing device 20 and via the coupled user interface 22 as well as on the mobile devices 16a, 16b. Similarly, for example, a backend 42 of the application 31 is stored on the server of the data cloud 18.

The diagram in FIG. 2 shows an architecture, by means of which the application 31 switches from the home screen 200 to a main activity 300. Here, firstly, a device ID 210 (device identifier) and a Bluetooth ID 212 (Bluetooth identifier) are determined. The device ID 210 is used to perform a request 214 to authorize access to the network 30, where the request 214 in a Boolean format only permits selection of a yes 1 or a no 0 and where:
if no 0 is selected, a device ID 210 is determined again by means of a loop 215 and a new request 214 is carried out; and
if yes 1 is selected, with the access authorization to the network 30, a connection is established 216 with the data cloud 18.
   Subsequently, a check 218 is carried out to see if certain user data of the mobile device 16a has been entered into a memory space 224 for respective user data within the data cloud 18. In other words, it is checked whether the mobile device 16a is already stored in the data cloud 18. In particular, the memory space 224 provided for the user data is contained in the data cloud 18, in which the user data of respective mobile devices 16a, 16 and the user data of the user are stored/entered.

Subsequently, a further request 220 to check already entered user data is made, where the request 220 in a Boolean format only permits selection of a yes 1 or a no 0 and where:
if yes 1 is selected, a first prompt 222 to input user data, in particular to input a name of the user is started, whereby the first user data of the newly entered mobile device 16a is stored in the memory space 224 provided therefor; and
if no 0 is selected, and thus if the mobile device 16a is already known, the main activity 300 is started.

After each start of the application 31 and thus after each login by means of the home screen 200, the device ID 210 and the Bluetooth ID 212 are stored in this memory space 224 provided therefor, so that the application 31 can assign the entered user data of the mobile device 16a and of the user every time they log in again and can access this data. In particular, this enables faster access to all user data required in the future when respective entered users log in and leads to faster execution of the application 31.

Similarly, FIG. 2 shows the mobile device 16a, representative for all mobile devices 16a, 16b, on which the application 31 can be used, with the display 17a on which the home screen 200 is shown, in particular with a welcome greeting and with an input field E1 for a text input, in particular for a name input for the prompt 222 to input user data, and with a confirmation button B1 to confirm the text input. Further text inputs with associated input fields and confirmation buttons can be modified depending on the design of the application 31, and this applies to all displays in the application 31.

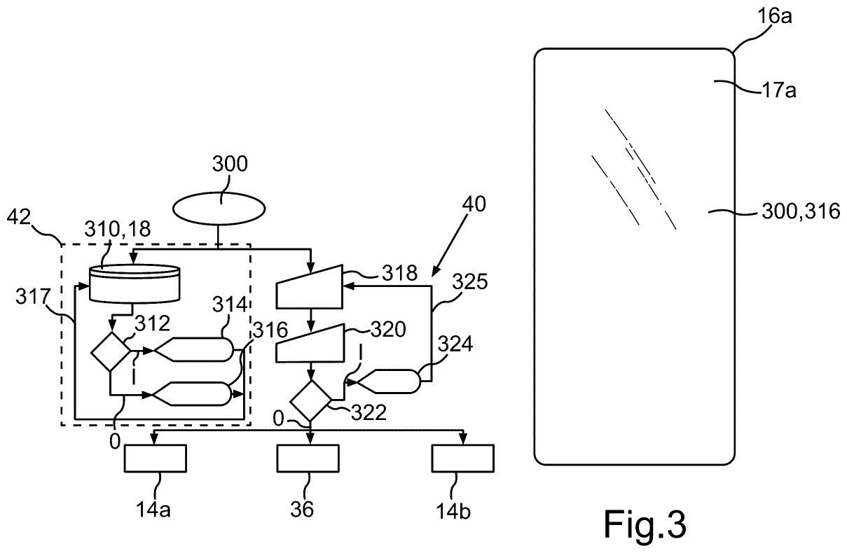

FIG. 3 shows a diagram illustrating an operating mode of the main activity 300 of the application 31 as well as the mobile device 16a, with the display 17a displaying the main activity 300.

In the main activity 300, first audio files 12a, 12b, 12c and/or a mixed playlist 38c are to be searched for in the backend 42 in a memory space 310 provided therefor from the data cloud 18 and loaded. For this, first a “greater than zero” (mixed playback list 38c>0) request 312 is made to determine the size of the searched for mixed playlists 38c, where the request 312 in a Boolean format permits only a yes 1 or a no 0, where:
for yes 1, the mixed playlist 38c has more than one audio file 12a, 12b, 12c and the first three audio files 12, 12b, 12c on the mixed playback list 38c are played back as top three songs in a first presentation 314 on the display 17a; and
for no 0, the mixed playlist 38c has zero audio files and in a second presentation 316 an empty playback list is reproduced on the display 17a.

Both answers yes 1 and no 0 to the request 312 are sent back to the memory space 310 of the data cloud 18 by means of an arrow shown in FIG. 3, thereby enabling a loop 317 to make a new request 312 for further playlists.

The main activity 300 also performs a prompt 318, in the case of which a user is prompted to input a search text to search for a desired mixed playback list 38c and thus start the search in the backend 42.

A counter 320 is then started which counts the selection of options the user on the frontend 40, in particular for later statistics and/or suggested improvements for the application 31. This is followed by another request 322 for checking a text input 324 of the search text in an input field provided therefor, where the request 322 in a Boolean format only permits selection of a yes 1 or a no 0 and where:
if yes 1 is selected, it is assumed that there is an empty input field and thus the user is shown a new text input 324 on the display 17a and whereby a loop 325 for a new prompt 318 to input a search text for the desired mixed playlist 38c is started; and
if no 0 is selected, it is assumed that there is a search text in the input field and thus the audio files 12a, 12b, 12c of the mixed playlist 38c provided by the external service providers 14a, 14b and stored in the internal memory 36 are provided for playback by the electronic computing device 20 and displayed on the display 17a.

In other words, by means of the main activity 300, the search for the desired playlist 38c with audio files 12a, 12b from the external service providers 14a, 14b and the audio files 12c 12b stored in the internal memory 36 is started for the user, so that they can listen to the desired audio files 12a, 12b, 12c via the loudspeaker device 23.

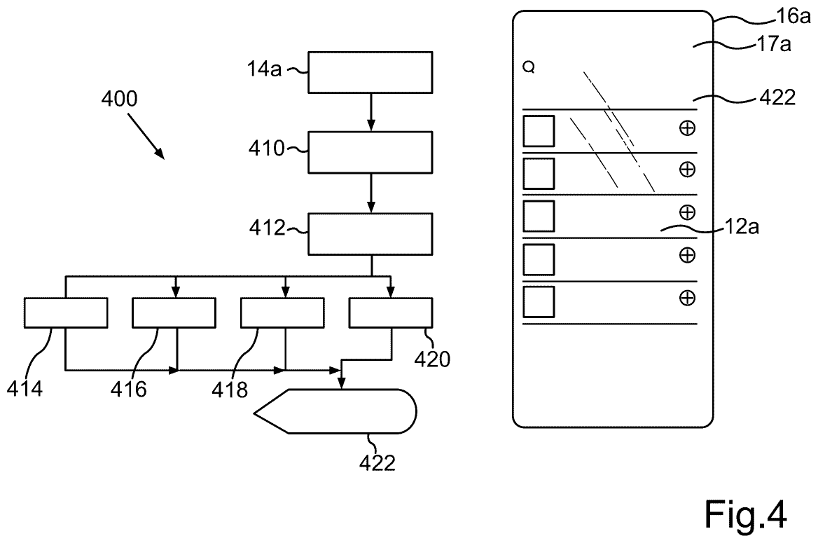

FIG. 4 shows a diagram illustrating an operating mode of a first search 400 of audio files 12a by means of the application 31 as well as the mobile device 16a with the display 17a displaying a results display 422 of the first search 400. The first search 400 relates to a specific search for audio files 12a from a first external service provider 14a, wherein firstly a search start 410 is started, in which a specific search text is transmitted to a user platform of the external service provider 14a. The top ten search results are taken from the search result 412, i.e., the first audio files suggested by the external service provider 14a for the specific search, wherein a respective title 414, a respective audio file ID 416 (audio file identifier), a respective preview image 418, and a respective access token 420 of the suggested audio files 12a are taken and, depending on the setting in the result display 422, are played back/displayed. This additional information can be used to create the playlist 38a and/or for further options/settings for the playback of respective audio files 12a. It is also possible to remove even more information from the database provided by the external service provider 14a in order to enable further processes.

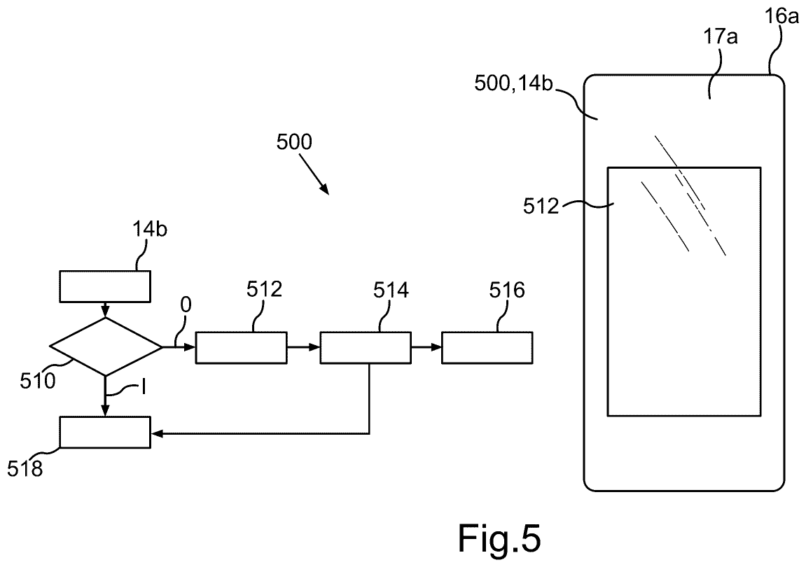

FIG. 5 shows a diagram illustrating an operating mode of a log-in display 500 for logging into a platform of an external service provider 14b as well as the mobile device 16a with the display 17a displaying the log-in display 500. First, a request 510 is made to check a user's login authentication, wherein the request 510 in a Boolean format only permits selection of a yes 1 or a no 0 and where:
if yes 1 is selected, an authorization 520 to access the platform of the external service providers 14b is approved;
if no 0 is selected, a login interface 512 of the external service provider 14b is displayed/opened in a Web view on the display 17a.
   A login process 514 takes place, in which the user registers with/logs into their own user account/account of the external service provider 14b. After the login process 514, authorization 520 is granted to access the platform of the external service provider 14b. Lastly, a save process 516 takes place, in which the external service provider 14b saves the user authentication and the access data or the linking to the application according to the invention in a memory space of the external service provider 14b, in order to enable future logins to be automatic and thus simplified, i.e. the user does not have to re-enter anything for future logins. Such login links or automatic logins are already known for all external service providers 14a, 14b.

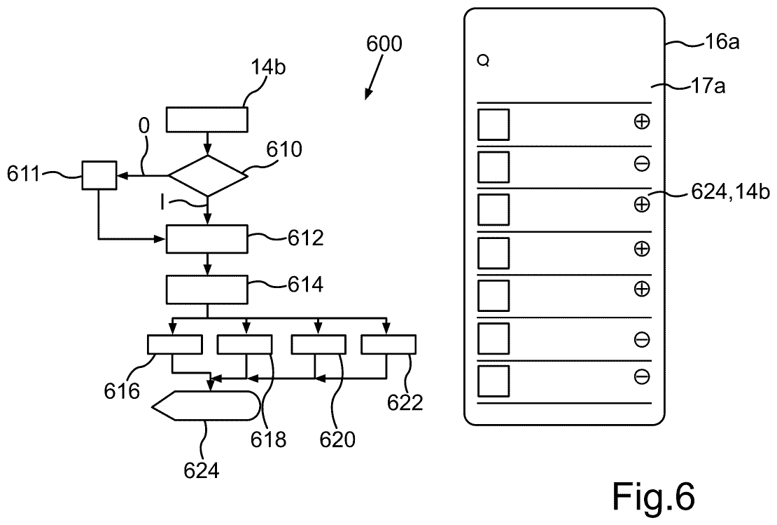

FIG. 6 shows a diagram illustrating an operating mode of a second search 600 for audio files 12b by means of the application 31 and the mobile device 16a with the display 17a displaying a results display 624 of the second search 600. Here, in contrast to the first search 400 shown in FIG. 4, the second search 600 is to search for audio files 12b from a further external service provider 14b on its platform.

Thus, the second search 600 is related to the second external service provider 14b, wherein, first, a request 610 is started for an already granted user authentication and thus a granted access authorization 611 of the user, wherein the request 610 in a Boolean format only permits selection of a yes 1 or a no 0 and where:
if no 0 is selected, the access authorization 611 is started by inputting user information in order to then start a search start 612 in which the search text is transmitted to the application programming interface (API) of the external service provider 14b; and
if yes 1 is selected, the search start 612 is started directly.
   With the search start 612, a specific search text is transmitted to a user platform of the external service provider 14b. The top ten search results are taken from a search result 614 of the search start 612, i.e., the first audio files suggested by the external service provider 14b for the specific search, wherein a respective title 616, a respective audio file ID 618 (audio file identifier), a respective preview image 620, and a respective access token 622 for the suggested audio files 12b are taken and, depending on the setting in the results display 624, are played back/displayed. This additional information can be used to create the playlist 38b and/or for further options/settings for the playback of respective audio files 12b. It is also possible to remove even more information from the database provided by the external service provider 14a in order to enable further processes.

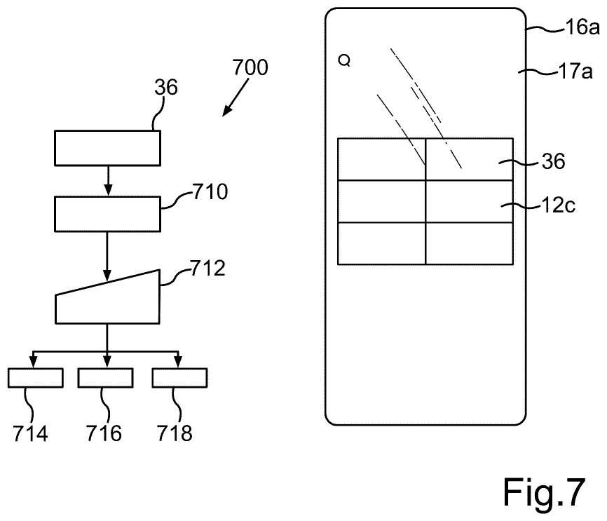

FIG. 7 shows a diagram illustrating an operating mode of a third search 700 for audio files 12c by means of the method as well as the mobile device 16a with the display 17a displaying a results display 720 for the results of the third search 700. Here, all already stored audio files 12c are displayed from the internal memory 36 of the electronic computing device 20, wherein first a navigation permission 710 is started. A determination 712 is made about the desired audio files 12c, where for all internally stored audio files 12c, the respective title 714, the respective audio file ID 716 (audio file identifier), and a respective preview image 718 are taken from the internal memory 36 and, depending on the setting in the results display 720, are played back/displayed. This additional information can be used to create the playlist 38c and/or for further options/settings for the playback of respective audio files 12c. It is also possible to remove even more information from the internal memory 36, to enable further processes.

Essentially, the first, the second, and the third search 400, 600, 700 are to provide the same information from the audio files 12a, 12b, 12c for the application 31, with the three searches 400, 600, 700 being exemplary and not final, and further embodiments of the operating modes or architectures are possible.

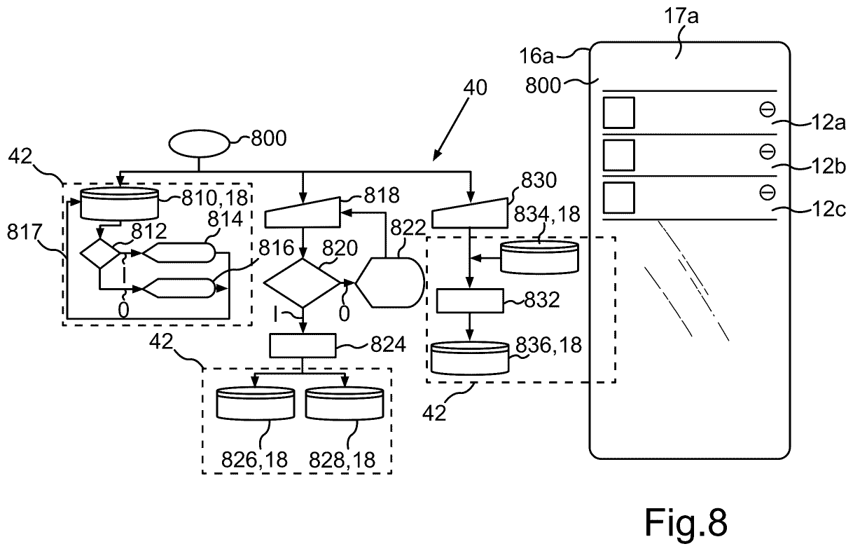

FIG. 8 shows a diagram illustrating an operating mode of a removal option 800 for removing audio files 12a, 12b, 12c from a playlist 38 of the application 31 as well as the mobile device 16a with the display 17a displaying the removal option 800.

In the case of the removal option 800, first audio files 12a, 12b, 12c and/or a mixed playlist 38c are to be searched for in the backend 42 in a memory space 810 provided therefor from the data cloud 18 and are loaded. For this, firstly a “greater than zero” (mixed playback list 38c>0) request 812 is made to determine the size of the mixed playlists 38c, where the request 812 in a Boolean format only permits a yes 1 or a no 0, where:
for yes 1, the mixed playback list 38c has more than one audio file 12a, 12b, 12c and the first three audio files 12, 12b, 12c on the mixed playback list 38c are played back as top three songs in a first representation 814 on the display 17a; and
for no 0, the mixed playback list 38c has zero audio files and in a second presentation 816 an empty playback list is reproduced on the display 17a.

Both answers yes 1 and no 0 to the request 812 are sent back to the memory space 810 of the data cloud 18 by means of an arrow shown in FIG. 3, thereby enabling a loop 817 to make a new request 812 for further playlists.

In a further activity of the removal option 800, removal 818 of certain audio files 12a, 12b, 12c is enabled, wherein, when a removal attempt 818 is made by a user, a request 820 is compared to a match in a comparison between a device ID (device identifier) assigned to the audio file to be removed and the device ID of the user. In particular, when an audio file is stored on a playlist, a device ID of the storing mobile device 16a is to be assigned to the stored audio file. With this identifier, the audio file is assigned to a mobile device 16a and can only be removed from this mobile device 16a. Alternatively, the audio file is assigned a user ID (user identifier).

The request 820 permits selection in a Boolean format of only a yes 1 or a no 0, where:
if no 0 is selected, a warning 822 is started, by means of which it is conveyed to the user that they are not authorized to remove an audio file 12a, 12b, 12c that is not linked to their personal device ID from the playback list 38c, and by means of a loop 823 a new request 820 is started.
   This means that a user, who has not added/stored this audio file 12, 12b, 12c in the mixed playlist 38c, is not granted permission to remove this audio file 12a, 12b, 12c from the mixed playlist 38c. In other words, the audio files 12a, 12b are only removed by the same user who also added them to the playlist 38. There is then again the option to remove 818 further audio files 12a, 12b, 12c, wherein:
if yes 1 is selected, i.e., a suitable request 820 of the IDs, a delete command 824 is transmitted, by means of which the specific audio file 12a, 12b, 12c is deleted from the mixed playback list 38c.

In the process, a delete command 824 is sent to the data cloud 18, where, firstly, a deletion of the audio files 12a, 12b, 12c is carried out in a first memory space 826 of the data cloud 18 and an addition is carried out in a second memory space 828 of the data cloud 18. Audio files 12a, 12b, 12c, which are added to a delete list of audio files to be deleted, are deleted from the playlist 38c after a predefined time.

Lastly, in the mixed playback list 38c, it is possible to add audio files 12a, 12b, 12c from all sources, with an option to add 830 being provided. An add command 832 is given, in the case of which audio files 12a, 12b, 12c are stored in a favorites list 900 in a memory space 836 provided therefor in the data cloud 18, with the user data from the memory space 834 of the data cloud 18 being checked and used for user data.

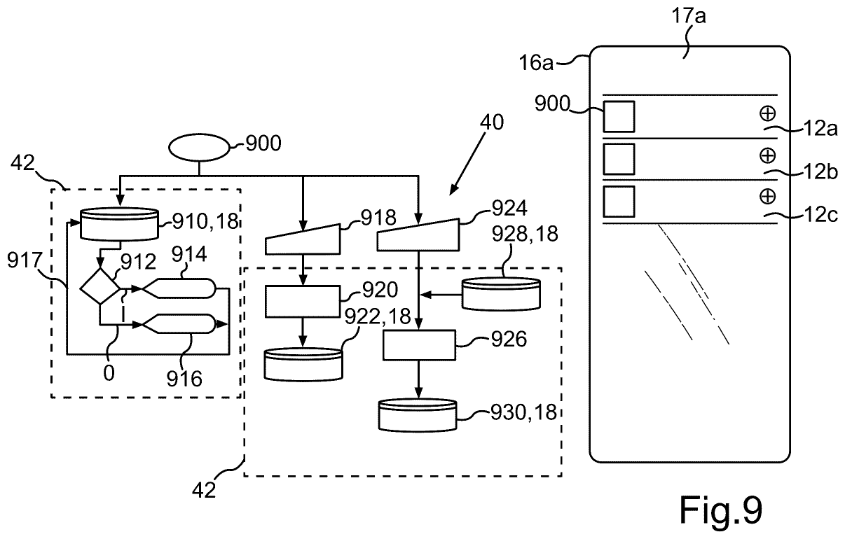

FIG. 9 shows a diagram illustrating the creation of the favorites lists 900 of the application 31 as well as the mobile device 16a with the display 17a displaying the favorites lists 900.

In the favorites lists 900, first audio files 12a, 12b, 12c and/or a mixed playlist 38c are to be searched for in the backend 42 in a memory space 910 provided therefor from the data cloud 18 and are loaded. For this, first a “greater than zero” (mixed playback list 38c>0) request 912 is made to determine the size of the mixed playlist 38c, where the request 912 in a Boolean format permits only a yes 1 or a no 0, where:
for yes , the mixed playback list 38c has more than one audio file 12a, 12b, 12c and the first three audio files 12, 12b, 12c on the mixed playlist 38c are played back as top three songs in a first presentation 914 on the display 17a; and
for no 0, the mixed playback list 38c has zero audio files and in a second presentation 916, an empty playback list is reproduced on the display 17a.

Both answers yes 1 and no 0 to the request 912 are sent back to the memory space 910 the data cloud 18 by means of an arrow shown in FIG. 3, thereby enabling a loop 917 to make a new request 912 for further playlists.

A removal 918 of certain audio files 12a, 12b, 12c from the favorites list 900 is also enabled, where a delete command 920 is sent to a memory space 922 in the data cloud 18 that is provided for the audio files 12a, 12b, 12c and the removal is carried out in the memory space 922.

Lastly, in the favorites lists 900, it is possible to add all audio files 12a, 12b, 12 from all sources, with an option to add 924 being provided. An add command 926 is given, in which audio files 12a, 12b, 12c are stored in the favorites list 900 in a memory space 930 provided therefor in the data cloud 18, with the user data from the memory space 928 of the data cloud 18 being checked and used for user data.

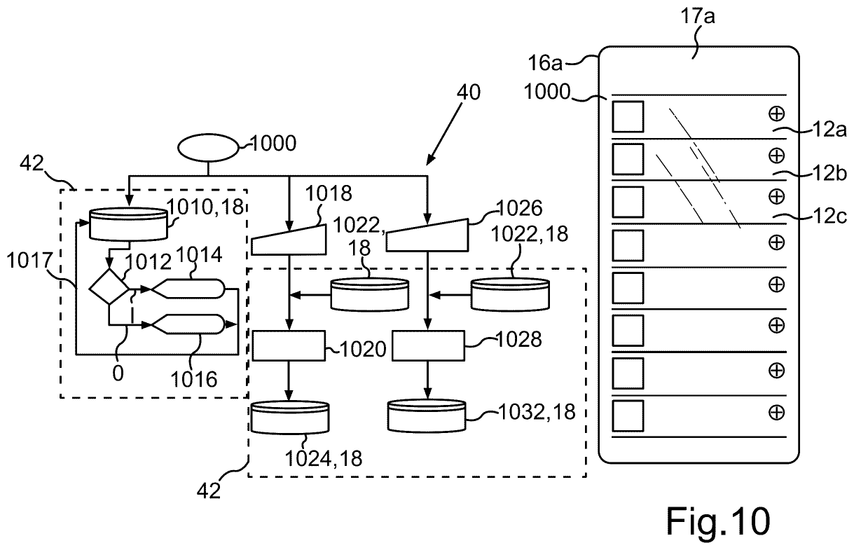

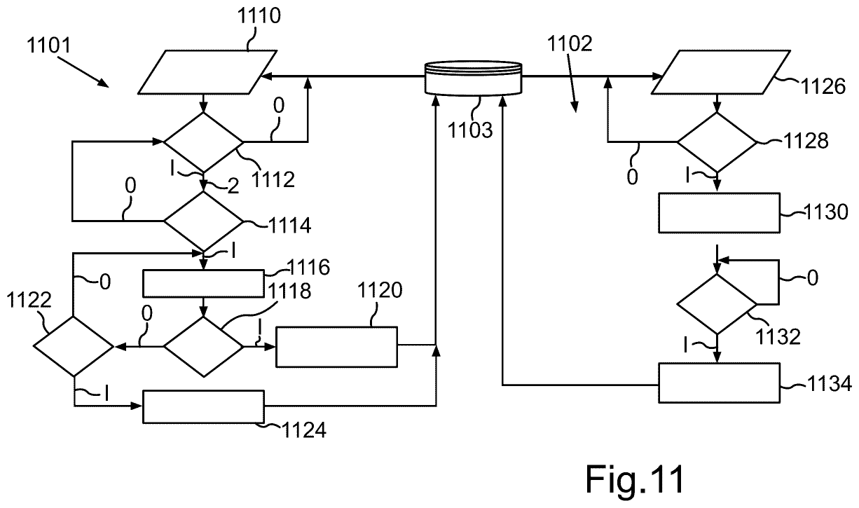

FIG. 10 shows a diagram illustrating the creation of a history 1000 of the application 31 as well as the mobile device 16a with the display 17a displaying the history 1000.

In the case of the history 1000, first audio files 12a, 12b, 12c and/or a mixed playlist 38c are to be searched for in the backend 42 in a memory space 1010 provided therefor from the data cloud 18 and loaded. For this, first a “greater than zero” (mixed playback list 38c>0) request 1012 to determine the size of the mixed playlist 38c is carried out, wherein the request 1012 in a Boolean format only permits a yes 1 or a no 0, where:
for yes 1, the mixed playback list 38c has more than one audio file 12a, 12b, 12c and the first three audio files 12, 12b, 12c on the mixed playlist 38c are played back as top three songs in a first presentation 1014 on the display 17a; and
for no 0, the mixed playback list 38c has zero audio files and in a second presentation 1016, an empty playlist is reproduced on the display 17a.

Both answers yes 1 and no 0 to the request 1012 are sent back to the memory space 1010 of the data cloud 18 by means of an arrow shown in FIG. 3, thereby enabling a loop 1017 to make a new request 1012 for further playlists.

It is also possible to remove 1018 certain audio files 12a, 12b, 12c from the history 1000, wherein a delete command 1020 is sent to a memory space 1024 in the data cloud 18 provided for the audio files 12a, 12b, 12c and the removal is carried out in the memory space 1024, with the user data from the memory space 1022 of the data cloud 18 being checked and used for user data.

Lastly, in the case of the history 1000, it is possible to add all audio files 12a, 12b, 12c from all sources, with an option to add 1026 being provided. An add command 1028 is given, in the case of which audio files 12a, 12b, 12c are stored in the history 1000 in a memory space 1032 provided therefor in the data cloud 18 stored are, with the user data from the memory space 1022 being checked and used for user data.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for playing back at least one audio file by an electronic computing device arranged in a vehicle, the method comprising:
wirelessly receiving, by at least one mobile device, a first audio file provided by a first external service provider;
wirelessly transmitting, by the at least one mobile device, the first audio file to a first communication module of the electronic computing device;
storing the first audio file in a data cloud coupled to the electronic computing device;
playing back the first audio file;
receiving, by the at least one mobile device, a second audio file provided by a second external service provider that is different from the first external service provider;
transmitting, by the at least one mobile device, the second audio file to the first communication module of the electronic computing device;
storing the second audio file in the data cloud; and
transmitting, directly to the electronic computing device for playback, the first and second audio files from the data cloud,
wherein the first and second audio files transmitted directly to the first communication module of the electronic computing device are stored by the electronic computing device in the data cloud, and
wherein the first and second audio files are transmitted directly to the first communication module of the electronic computing device by a second communication module of the at least one mobile device to add the first and second audio files to a playlist.

11. The method of claim 10, wherein further audio files from a second memory are played back by the electronic computing device.

12. The method of claim 10, wherein the playlist comprising the first and second audio files stored in the data cloud is controlled via the at least one mobile device and via a user interface of the electronic computing device.

13. The method of claim 12, wherein a removal authorization is checked prior to removing audio files from the playlist.

14. The method of claim 10, wherein at least one item of information about at least one user of one of the at least one mobile device is stored in the data cloud.

15. An electronic computing device configured to play back audio files, the electronic computing device comprising:
a first communication module configured to wirelessly couple the electronic computing device to a data cloud; and
at least one second communication module configured to wirelessly couple the electronic computing device to at least one mobile device without a cable,
wherein the electronic computing device is configured to store or play back all audio files in an order in the data cloud, depending on signals sent to the first and at least one second communication modules from the respective mobile devices, and
wherein the at least one second communication module is further configured to wirelessly receive the audio files directly from the at least one mobile device and to store the received audio files in the data cloud.

16. The electronic computing device of claim 15, wherein the electronic computing device is configured to buffer store and play back audio files stored in the data cloud.

17. The electronic computing device of claim 16, wherein the electronic computing device is configured as a single-board computer that emulates an infotainment system of a vehicle or the electronic computing device is coupled to a single-board computer that emulates an infotainment system.
